(19) United States
(12) Patent Application Publication
(10) Pub. No.: US 2022/0152744 A1
(43) Pub. Date: May 19, 2022

(54) BEAM MACHINING PLATE-LIKE OR TUBULAR WORKPIECES

(71) Applicant: WSoptics technologies GmbH, Rettenbach am Auerberg (DE)

(72) Inventors: Florian Sepp, Altenstadt (DE); Christoph Weiss, Schongau (DE)

(21) Appl. No.: 17/586,991

(22) Filed: Jan. 28, 2022

Related U.S. Application Data
(63) Continuation of application No. PCT/EP2020/062953, filed on May 8, 2020.

(30) Foreign Application Priority Data
Jul. 29, 2019 (EP) 19188961.7

(51) Int. Cl. B23K 26/38; B23K 26/08; B23K 26/361; B23K 26/352; B23K 26/144

(52) U.S. Cl. CPC B23K 26/38; B23K 26/0876; B23K 26/144; B23K 26/3576; B23K 26/361

(57) ABSTRACT

Methods, devices, and systems for beam processing of plate-shaped or tubular workpieces are provided. In one aspect, a method includes: generating at least one section of a cutting gap cutting through the workpiece along a cutting line corresponding to at least part of a contour of a workpiece part to be produced from the workpiece by a processing beam, and performing at least one non-joining and non-cutting finishing treatment of the workpiece with a partially cut-out workpiece part at least in one section of at least one finishing zone by the processing beam, the finishing zone extending along the cutting line.

### CROSS REFERENCE TO RELATED APPLICATIONS

This application is a continuation of and claims priority under 35 U.S.C. § 120 from PCT Application No. PCT/EP2020/062953, filed on May 8, 2020, which claims priority from European Application No. 19 188 961.7, filed on Jul. 29, 2019. The entire contents of each of these priority applications are incorporated herein by reference.

### TECHNICAL FIELD

The present disclosure relates to manufacturing metallic workpiece parts, particularly, to beam processing of plate-shaped or tubular workpieces.

### BACKGROUND

Commercially available laser cutting devices with a movable beam head for guiding a laser beam enable automated production of workpiece parts in large quantities and with high precision. In this process, workpiece parts are cut out of a plate-shaped or tubular metallic workpiece along respective cutting lines by means of the laser beam. This is done by means of a relative movement between the beam head and the workpiece.

Depending on the type of laser cutting process used, the cut edges of the cut workpiece parts usually require extensive mechanical finishing. Sharp cut edges have to be rounded, for example with a chamfer, and burrs on the cut edges have to be removed. Furthermore, the cut edges often have to be prepared for a later processing process, for example by smoothing or roughening. Another problem is the oxidation that occurs at the cut edges during laser cutting with oxygen as the working gas. Since oxide layers are usually difficult to paint, they have to be removed by grinding. Another problem is that the coating on coated, especially galvanized, workpieces is lost in the area of the cutting gap, so that the workpieces made from coated workpieces either have to be recoated or a coating is generally only applied to the cut-out workpieces.

In principle, the machining in the area of the cutting edges after the complete cutting out of a workpiece part is very time-consuming and usually also very personnel-intensive, especially since it is often also carried out manually. In addition, the finishing is cost-intensive, so that the production of workpiece parts is undesirably prolonged and made more expensive.

### SUMMARY

One object of the present disclosure is to develop processes, in which workpiece parts are cut out from a plate-shaped or tubular workpiece by a cutting beam, in such a way that the production of workpiece parts can be carried out in an automated manner more quickly, more economically, and with high quality.

The present disclosure provides processes for the beam processing of plate-shaped or tubular workpieces. The processes according to the present disclosure can be used in any process in which the generation of a cutting gap in a workpiece is effected by a cutting beam (thermal cutting), for example laser cutting or flame cutting. The processes according to the present disclosure can be used in laser cutting, wherein the processing beam is a laser beam and the beam processing is laser beam processing.

In the present disclosure, the term “workpiece” means a plate-shaped or tubular component, e.g., a metallic component, from which at least one workpiece part (good part) is to be produced from the workpiece. The plate-shaped workpiece can be flat or planar.

Although the processes according to the present disclosure for beam processing a plate-shaped or tubular workpiece is explained for a single workpiece part, it is understood that, as a rule, a plurality of workpiece parts can be produced from the workpiece.

Since in the processes according to the present disclosure, in addition to a cutting of the workpiece to create a cutting gap, a non-separating and at the same time non-joining finishing (e.g., finishing treatment or post-treatment) of the workpiece is also carried out, the more general term “processing beam” is used instead of cutting beam. It is understood that by adjusting its power density, the processing beam can be used optionally for the cutting processing or alternatively for the non-separating and at the same time non-joining processing of the workpiece. The term “finishing” can mean a finishing treatment or a post-treatment after creating a cutting gap.

The energy density of the processing beam indicates the energy of the processing beam in relation to the area of the workpiece irradiated by the processing beam, for example, measured in J/mm². Relevant for the creation of the cutting gap and the finishing of the workpiece is the energy density in relation to the time interval in which the irradiated surface of the workpiece is irradiated, for example measured in J/(mm²xs), referred to here and in the following as “power density.” If the power density absorbed by the workpiece is of essential importance, the power density can also be understood as the power density absorbed by the workpiece.

According to the present disclosure, the beam processing of a plate-shaped or tubular workpiece includes the creation of a cutting gap cutting through the workpiece along a cutting line of at least one workpiece part. The cutting line corresponds to a contour (outline) of a workpiece part to be produced from the workpiece. The cutting line is completely provided with a cutting gap, e.g., it is cut through.

When creating the cutting gap, the beam head is moved above the workpiece to guide the processing beam, whereby the processing beam is guided along the cutting line. The cutting line is thus a predetermined or predefined (imaginary) line or path along which the processing beam or beam head is guided to cut out the workpiece part contoured by the cutting line. During the cutting machining of the workpiece, the processing beam has a first power density that is dimensioned in such a way that the workpiece is (completely) cut through. The processing beam interacts with a working gas beam directed at the cutting gap. The first power density can assume different power density values, so it does not have to be constant.

In the present description of the present disclosure, the reference system can be stationary with respect to the workpiece, so that the beam head is considered to be moving and the workpiece is considered to be stationary. From a local point of view, however, it is irrelevant whether the beam head or the workpiece or both are moved. In this respect, it would be equally possible for the workpiece to be moved in addition to the moving beam head, or that both the beam head and the workpiece are moved.

By creating the cutting gap along the cutting line, the workpiece part is partially or completely cut out along its contour, i.e., the cutting gap is contour-forming. Accordingly, the term “cutting gap” in the present disclosure does not include sections of the cutting gap that are not contour-forming and do not extend along the contour of the workpiece part. For example, when cutting out a workpiece part, the workpiece can be pierced away from the contour and the cutting beam is only moved a short distance towards the contour-forming cutting line of the workpiece part. The resulting cutting gap in the workpiece is not contour-forming and thus does not fall under the term cutting gap as it is to be understood in the present disclosure.

Cutting a workpiece part free from the workpiece, i.e., cutting the workpiece part completely out of the workpiece so that it can be detached or removed from the workpiece, is done by creating a closed cutting gap along the cutting line (contour) of the workpiece part. However, it is also possible that the cutting gap only extends along one or more sections of the contour of the workpiece part, so that the workpiece part is only partially cut out by the processing beam and the workpiece part continues to be connected to the workpiece. In some embodiments, the workpiece part is cut free (i.e. completely cut out) by the processing beam. The cutting gap can be divided into different sections that are produced one after the other and successively lengthen the cutting gap, for example.

If at least one workpiece part is completely cut out of the workpiece (e.g., cut free), the remaining workpiece can be referred to as a “residual grid”. For the purposes of the present disclosure, when the at least one workpiece part to be cut out is at least mentally removed, the remaining workpiece is referred to as a residual grid. According to the present disclosure, the workpiece is finished if the workpiece part is only partially, i.e., not completely, cut out. For ease of reference, the remaining workpiece without the area within the contour of the at least one workpiece part to be cut out is referred to as the residual grid, even if the workpiece part has not yet been cut free. The cutting gap can be therefore delimited by two opposite cutting edges, e.g., a cutting edge on the workpiece part side and a cutting edge on the residual grid side.

For the purposes of the present disclosure, the term “cutting out” includes both the complete cutting out and the partial cutting out of a workpiece part from the workpiece. A partially cut-out workpiece part is still firmly connected to the rest of the workpiece (residual grid), i.e., the partially cut-out workpiece part is still an integral part of the workpiece. In the present disclosure, the connection of a partially cut-out workpiece part to the remaining workpiece (residual grid) is sufficiently rigid so that a change in position of the partially cut-out workpiece part relative to the remaining workpiece (residual grid) does not occur during finishing of the workpiece, or any change in position that does occur is negligible and does not lead to any change in the result during finishing of the workpiece that can reasonably be taken into account.

According to the present disclosure, the workpiece is finished with a partially cut out workpiece part along the cutting line. The partially cut out workpiece part can remain connected to the workpiece during finishing by one or more so-called microjoints. These are webs of small dimensions, with such microjoints, e.g., having a maximum dimension of 1.5 mm along the contour of the workpiece part. In some embodiments, the partially cut-out workpiece part is connected to the workpiece by an area, which along the contour or cutting line, can have, for example, a dimension of at least 2 mm, at least 3 mm, or at least 5 mm. This can apply to conventional workpieces made of sheet metal with sheet thicknesses in the range of 0.5 mm to 30 mm. In some cases, microjoints can be cut through manually (for example by breaking them out). In contrast, in the present disclosure, the cutting free of a partially cut out workpiece part from the workpiece can be carried out by the processing beam.

In the processes according to the present disclosure, at least one section (i.e., one or more sections) of a cutting gap cutting through the workpiece along a cutting line corresponding to at least part of a contour of a workpiece part to be produced from the workpiece is generated by the processing beam. In some embodiments, the cutting line corresponds to the (complete) contour of a workpiece part to be produced from the workpiece. In this case, the workpiece part is only partially cut out, i.e., it is still firmly connected to the workpiece (residual grid).

Subsequently, the workpiece (e.g., partially cut-out workpiece part and/or residual grid) is finished one or more times with partially cut-out workpiece part by the processing beam, where the finishing is carried out in at least one section (i.e., in one or more sections) of at least one finishing zone extending along the cutting line. The workpiece is finished in a non-joining and at the same time non-separating manner during the finishing. The at least one finishing zone extends along the cutting line. The at least one section in which a finishing of the workpiece is carried out may extend along the cutting gap or a section of the cutting gap, provided that the cutting gap has previously been created. In principle, a finishing of the workpiece is carried out along the cutting line.

The creation of the cutting gap along the cutting line can be done in one or more steps. In some embodiments, the cutting gap is created in sections along the cutting line, e.g., several sections of the cutting gap are created, which together complete the cutting gap. In some embodiments, a previously created section of the cutting gap is extended when another section is created, so that the cutting gap is successively extended. When creating the cutting gap section by section, the traversing movement of the beam head and the cutting machining of the workpiece is thus not continuous, but is interrupted at least once, e.g., by a single or multiple finishing of the workpiece.

Like the creation of the cutting gap, the finishing of the workpiece can also be carried out in sections, e.g., the finishing can be carried out successively, for example separated by a cutting machining of the workpiece, in several sections of at least one finishing zone. Multiple finishing (treatments) of the workpiece may also take place in several different finishing zones. In the process according to the present disclosure, finishing of the workpiece can also take place in an area of the workpiece along the cutting line that does not have a cutting gap, in particular immediately before the workpiece part is cut free.

It is essential that the at least one workpiece part is not completely, but only partially, cut out of the workpiece in the region of the workpiece part during finishing of the workpiece, and in this case is so firmly (rigidly) connected to the workpiece that a change in position of the partially cut-out workpiece part relative to the residual grid does not occur or is so small that it does not reasonably have to be taken into account during finishing. This is a great advantage of the present disclosure, since a finishing of the workpiece along the cutting line, in particular along a previously created cutting gap, can be carried out reliably and safely with great accuracy. In contrast, the relative positioning of a workpiece part that has previously been cut free relative to the residual grid is generally undefined, so that finishing of the workpiece part is fraught with considerable inaccuracy and consequently such quality defects occur that such a procedure is not useful, at least in the industrial series production of workpiece parts. To avoid this, corresponding measures would be necessary for an exact positioning of the workpiece part, which is associated with additional production costs. In addition, the time required to produce a workpiece part is extended.

According to the present disclosure, the workpiece is finished along the cutting line of the partially cut out workpiece part. Finishing the workpiece comprises finishing the workpiece part itself, e.g., that area of the workpiece that is on one side of the cutting line belonging to the workpiece part. In the case of a closed cutting line (contour), the workpiece part is located within the closed contour, e.g., the area within the closed contour is finished. Finishing the workpiece also includes finishing the residual grid, i.e., that area of the workpiece that is on the other side of the cutting line that does not belong to the workpiece part. In the case of a closed cutting line (contour), the area outside the closed contour is finished. In the case of a non-closed cutting line, this applies accordingly, whereby finishing of the workpiece can take place on both sides of the cutting line. It is essential here that finishing is not restricted to the workpiece part as such, but that the residual grid (with the workpiece part partially cut out) can also be subjected to finishing. This is made clear by the general wording “finishing of the workpiece.”

The cutting gap is created along the cutting line, whereby the cutting gap extends over the complete cutting line. If the workpiece part is completely cut out (cut free), according to the present disclosure, neither the cut free workpiece part nor the remaining residual grid (e.g., residual grid without cut free workpiece part) is finished. The finishing of the workpiece can thus take place along a cutting line of a workpiece part still to be cut out, in particular also along the cutting gap, if such a gap has previously been created.

When finishing the workpiece, the processing beam has a second power density that is smaller than the first power density used for the cutting machining of the workpiece, whereby the workpiece is finished in a non-joining and at the same time non-separating manner. This means that if a cutting gap has previously been created, when the workpiece is finished, the partially cut out workpiece part is not rejoined to the remaining grid across the cutting gap. Similarly, when finishing the workpiece, no breakthrough of the workpiece is created.

During finishing, the processing beam, which is not a cutting beam here but a finishing beam due to its power density, is guided along a finishing line. The finishing line is a predefined or predefined (imaginary) line or path along which the processing beam or beam head is guided to guide the processing beam.

A finishing of the workpiece takes place at least in a section of at least one finishing zone, which extends along the cutting line. The at least one finishing zone results from the irradiation by the processing beam. The finishing zone can be wider than the (imaginary) finishing line due to the beam widening.

In some embodiments, the finishing line and the cutting line can be identical. Alternatively, the finishing line and the cutting line are not identical. For example, the finishing line can be laterally offset from the cutting line, whereby the finishing line can have a constant perpendicular (shortest) distance to the cutting line, e.g., the finishing line and the cutting line are equidistant lines.

In some embodiments, the partially cut-out workpiece part is cut free (i.e., completely cut out) along the cutting line by the processing beam after the workpiece has been finished one or more times.

In some embodiments, the cutting gap is created in sections, whereby at least two sections of the cutting gap are created, which together form the cutting gap. The traversing movement of the beam head and the separating processing of the workpiece are thus interrupted at least once.

In some embodiments, the workpiece is finished one or more times between the creation of two sections of the cutting gap in at least one section of at least one finishing zone. In some embodiments, the workpiece is finished one or more times in a section of at least one finishing zone which extends at least partially, in particular completely, along a previously created, for example an immediately previously created, section of the cutting gap. It is possible that the workpiece is finished along several previously created sections of the cutting gap or parts thereof. A microjoint (i.e., a minimal interruption of the cutting gap) may remain between the sections of the cutting gap.

For example, when the cutting gap is created in sections, finishing of the workpiece is only performed along one (e.g., immediately) previously created section of the cutting gap, wherein the creation of two immediately adjacent sections of the cutting gap is interrupted by at least one finishing of the workpiece along the (e.g., immediately) previously created section of the cutting gap. The section of the at least one finishing zone in which the finishing takes place may extend along the complete (immediately previously generated) section of the cutting gap or only a part thereof. In the case of multiple finishing, this can take place in several finishing zones that are different from each other. In some embodiments, the beam head is moved between two cutting operations of the workpiece, whereby the processing beam can be switched off for this movement. The beam head can also be moved over the workpiece, in particular also within the contour of the workpiece part. For example, the beam head is moved from a respective first cutting position to a respective second cutting position when creating a section of the cutting gap. Subsequently, the beam head is moved from a respective first finishing position to a respective second finishing position for finishing the workpiece along the generated portion of the cutting gap. The first finishing position may be identical to or different from the first cutting position. The second finishing position may be identical to or different from the second cutting position.

The workpiece can be finished one or more times along a complete section of the cutting gap. However, it is also possible that the workpiece is only finished once or several times within a part of the section of the cutting gap.

In some embodiments, the workpiece is finished in a section of the finishing zone, which at least partially does not have a section of the cutting gap, for example, in continuous continuation of the finishing in a section of the finishing zone which extends along a section of the cutting gap. Thus, it is possible that the workpiece is further finished beyond the cutting gap along the cutting line, in particular in an area of the workpiece in which no cutting gap has yet been created, e.g., immediately before the workpiece is cut free at a connecting web (e.g., microjoint) between the workpiece part and the residual grid, whereby the workpiece part is cut free by cutting through the connecting web or is broken out manually. After finishing, the partially cut-out workpiece can also be cut free by cutting through the connecting web, for example by the processing beam.

This procedure has the particular advantage that the workpiece can be finished one or more times along the complete (closed) cutting line, e.g., the workpiece part that is later cut free, for example, by the processing beam, can have one or more finishings (or finishing treatments) along its complete contour. In a corresponding manner, the residual grid can be provided with a single or multiple finishing operations along the complete cutting gap. This can be particularly advantageous when producing an aperture within a good part, whereby a finishing operation can be carried out all the way around along the cut edge of the aperture. Investigations described herein have shown, a particularly satisfactory result can be achieved in the finishing operation by the new procedures described herein. This is a major advantage of the processes according to the present disclosure.

As explained, when the cutting gap is generated section by section, a plurality of sections of the cutting gap are generated, wherein the cutting machining of the workpiece can be interrupted at least once, in particular several times, to carry out a one or several times finishing of the workpiece along the cutting line, for example of the cutting gap or of a part of the cutting gap. In some embodiments, a last generated section of the cutting gap has a length along the cutting line that is smaller than the respective length of any other previously generated section of the cutting gap. For example, the lengths of the successively created sections of the cutting gap, as viewed from a clearance point of the workpiece part, do not decrease against the direction of creation of the cutting gap. Since finishing of the workpiece only takes place when the workpiece part is still firmly connected to the workpiece, it can be achieved by this measure in a particularly advantageous manner that the workpiece can be finished along as large a part of the cutting line as possible. A non-finished part of the workpiece, with which the partially cut out workpiece part is still connected to the workpiece, is thus small compared to the worked part along the cutting gap.

In some embodiments, a layer of an anti-adhesive agent is applied to the workpiece in at least one section of at least one finishing zone before finishing the workpiece. The anti-adhesive agent layer is designed to inhibit adhesion of substances generated during finishing, such as melt or slag. The anti-stick layer can contain a release agent, for example an oil.

In principle, the finishing line can have a different course from the cutting line. According to one or more embodiments of the present disclosure, the processing beam is guided with a meandering movement along at least one section of the cutting line when finishing the workpiece. In some embodiments, the finishing line has a meandering course along the cutting line, which makes it possible to widen the finishing zone in a simple manner. The finishing zone created in this way continues to extend along the cutting line. The term “meandering course” is to be understood in a general sense. This includes all movements of the processing beam that have reciprocating movements of the processing beam with oppositely directed movement components perpendicular to the cutting line. In some embodiments, the oppositely directed movement components have the same dimensions so that the meandering course is uniform. For example, the meandering course is sinusoidal.

The processes according to the present disclosure includes finishing the workpiece once or several times in at least one section of at least one finishing zone after producing at least one section of the cutting gap. In the case of a first, in particular also single, finishing of the workpiece in at least one section of a finishing zone, the finishing line can have a course such that the workpiece is irradiated by the processing beam in a region containing a workpiece part-side cut edge of the cutting gap and/or in a region containing a residual grid-side cutting edge of the cutting gap. In some embodiments, one cutting edge is finished, whereby the other cutting edge is also irradiated.

For the purposes of the present disclosure, the term “cutting edge” refers to the two opposing (cross-sectional) surfaces of the residual grid and the workpiece part, which together form the cutting gap. The cutting edges can be perpendicular to the plane of a plate-shaped (flat) workpiece or perpendicular to a tangential plane in the region of the cutting gap of a tubular workpiece. In accordance with the use of the term “residual grid” according to the present disclosure, the cutting edge of the workpiece which is opposite the cutting edge of the partially cut-out workpiece part is referred to as the “residual grid-side cutting edge”, irrespective of the fact that the workpiece part is not completely but only partially cut out. In addition to the respective cutting edge, the finished area can also have a section of the workpiece extending transversely to the cutting edge. However, it is also possible that only the workpiece part-side cutting edge and/or the residual grid-side cutting edge of the cutting gap is finished without irradiating further sections of the workpiece that are not part of a cutting edge.

According to one or more embodiments of the present disclosure, when finishing the workpiece, at least a portion of at least one finishing zone includes a workpiece part-side cutting edge of the cutting gap and/or a residual grid-side cutting edge of the cutting gap.

In some embodiments, the workpiece is finished several times in at least one section of at least one finishing zone. During the first finishing, the finishing zone can include the cutting edge on the workpiece part side and/or the cutting edge of the cutting gap on the residual grid side. In a subsequent reworking, the finishing zone can contain the workpiece part-side cutting edge and/or the residual grid-side cutting edge of the cutting gap, although it is equally possible that it does not contain the workpiece part-side cutting edge and/or the residual grid-side cutting edge of the cutting gap. For example, a first finishing is carried out in a finishing zone or a section of the finishing zone, which contains the workpiece part-side cutting edge and/or the residual grid-side cutting edge of the cutting gap, and with each further finishing the cutting edges are not contained in the finishing zone or section of the finishing zone. This embodiment can be particularly advantageous when creating a chamfer at the cutting gap. In particular, a chamfer can be created starting from a finished cutting edge. During the at least one subsequent finishing operation, the cut edge no longer has to be irradiated, but the processing beam can be displaced further into the workpiece part or residual grid in the direction away from the cutting edge, for example in order to widen the chamfer.

In the case of multiple finishings, a finishing zone of a subsequent finishing can, for example, contain at least partially a finishing zone of a preceding finishing.

If several finishing operations are carried out, the same or different finishing lines and/or the same or different power densities of the processing beam can be used. In an embodiment of the process according to the present disclosure, at least two finishing operations performed in the same section of the finishing zone have different finishing lines and/or different power densities of the processing beam.

The direction for finishing the workpiece can be the same as or opposite to the direction in which the cutting gap is or was created.

The beam axis of the processing beam is preferably always directed perpendicularly to the plate-shaped or tubular workpiece or always perpendicularly to the workpiece surface when cutting the workpiece, although it is also conceivable that the beam axis deviates from the perpendicular. When finishing the workpiece, the beam axis of the processing beam can be directed perpendicularly to the plate-shaped or tubular workpiece or perpendicularly to the workpiece surface, although it is also conceivable that the beam axis deviates from the vertical.

“Alignment” of the processing beam means the angle between the center beam of the beam cone (e.g., beam axis) of the processing beam hitting the workpiece and the flat workpiece surface of the workpiece. In the case of a tubular workpiece, a tangential plane to the workpiece surface is considered at the point of impact of the beam axis. With a perpendicular alignment of the processing beam, the angle between the beam axis and the workpiece surface is 90°.

According to an embodiment of the methods according to the present disclosure, the orientation of the processing beam when irradiating the workpiece for finishing is always unchanged and equal to an always unchanged orientation of the processing beam when irradiating the workpiece for creating the cutting gap. For example, the processing beam can be always directed perpendicular to the workpiece surface when cutting and finishing the workpiece. The beam axis of the processing beam thus remains unchanged during the creation of the cutting gap and during finishing. This measure can considerably simplify the machining of the workpiece in terms of control technology. In addition, costs for the technical implementation of a corresponding swiveling capability of the beam head and/or processing beam relative to the workpiece can be saved.

According to an alternative embodiment of the methods according to the present disclosure, the orientation of the processing beam when irradiating the workpiece for finishing the workpiece can be at least temporarily different from the orientation of the processing beam when cutting the workpiece. In particular, the beam axis may at least temporarily assume an angle different from 90° to the workpiece surface during reworking. The alignment of the machining beam can be achieved by swiveling the beam head (mechanically) and/or swiveling the machining beam (optically).

When cutting the workpiece, the processing beam or its beam axis is guided along the cutting line. The cutting line thus defines the path of the processing beam on the workpiece surface when creating the cutting gap for a workpiece part to be cut out. During finishing, the processing beam or its beam axis is guided along the finishing line.

The finishing line thus defines the path of the processing beam on the workpiece surface when finishing the workpiece along the cutting gap. The finishing zone results from the area of the workpiece that is irradiated during finishing.

The processing beam can be controlled by moving the beam head and/or by changing the orientation of the beam head relative to the workpiece surface (swiveling of the beam head) and/or by changing the direction of the beam relative to the beam head (optical swiveling of the processing beam relative to the beam head which is unchanged in its orientation). In some embodiments, the processing beam is controlled only by moving the beam head, whereby the orientation of the beam head relative to the workpiece surface and the orientation of the processing beam relative to the beam head remain unchanged during the beaming processing of the workpiece (cutting processing and finishing), which avoids complex and cost-intensive technical equipment.

According to an embodiment of the processes according to the present disclosure, the distance of the finishing line from the cutting line (finishing line is preferably offset equidistantly from the cutting line) is at most half the gap width of the cutting gap plus the radius of a jet cone of the processing beam at the workpiece surface. However, it is also possible that the distance of the finishing line from the cutting line is greater, for example in the multi-stage production of a chamfer, in which the finishing line in a subsequent finishing operation is arranged further away from the cutting gap than the finishing line of a previous finishing operation. In the case of multi-stage production of a chamfer, the finishing zone in the first finishing operation contains at least one cutting edge, the finishing zones in the at least one subsequent finishing operation preferably not containing the cutting edge.

For example, the travel curve of the beam head during finishing is laterally offset (in particular equidistant) from the travel curve of the beam head during cutting. The travel curve of the beam head during finishing and the travel curve of the beam head during cutting can have a parallel course.

During the finishing of the workpiece, the processing beam has a second power density which is different from the first power density and which is dimensioned or controlled in such a way that a non-joining and at the same time non-cutting (but possibly re-melting) finishing of the workpiece is effected. Thus, during the finishing, neither a connection between the partially cut out workpiece part and the workpiece (residual grid) is created across the cutting gap, nor is the workpiece cut through. Here, the influence of the working gas is taken into account, whereby according to the present disclosure, the power density of the processing beam can also be understood as the power density absorbed by the workpiece. A change in the power density or the absorbed power density can be achieved by various measures, in particular by changing the energy of the processing beam, changing the beam focus, changing the distance of the beam head from the workpiece surface, changing the type and/or parameters of the working gas and the like. The person skilled in the art is well aware of the measures for changing the power density, so that it is not necessary to go into more detail here. In some embodiments, the power density is changed exclusively by changing the vertical distance of the beam head from the workpiece surface.

For example, the second power density can be less than 50%, less than 40%, less than 30%, less than 20%, less than 10%, or less than 1% of the first power density.

In the process according to the present disclosure for the beam machining of a plate-shaped or tubular workpiece, the finishing of the workpiece can be carried out in a wide variety of ways, whereby the finishing line and the second power density of the processing beam are to be selected in a suitable manner depending on the type of finishing. The processes according to the present disclosure can be used for a large number of different finishing operations, of which seven application cases are given below as examples.

In a first application, an oxide layer is removed from the cutting edge on the workpiece part side and/or the residual grid side of the cutting gap. This can save the removal of the oxide layer on the completely cut out workpiece part. If necessary, the irradiated area can be limited to the cutting edge(s).

In a second application, burr (e.g., micro burr) is removed from the workpiece part-side cutting edge and/or the residual grid-side cutting edge of the cutting gap. The burr is often located adjacent to the workpiece surface (facing the processing beam) and/or adjacent to the workpiece underside (facing away from the processing beam). The irradiated area may be limited to the cutting edge(s), if applicable.

In a third application, the workpiece part-side cutting edge and/or the residual grid-side cutting edge of the cutting gap is rounded (by re-melting). Here, the finishing line can be laterally offset relative to the cutting line in the direction of the cutting edge to be machined, preferably by a maximum of half the width of the cutting gap plus the radius of the beam cone of the processing beam on the workpiece surface.

In a fourth application, the shape of the cutting edge on the workpiece part side and/or the cutting edge of the cutting gap on the residual grid side are changed (by re-melting), for example smoothed or roughened, for example to improve a joining process.

In a fifth application, a chamfer is created on the workpiece part-side cutting edge and/or the residual grid-side cutting edge of the cutting gap. This can also be done in several steps, whereby according to a preferred embodiment the finishing line is arranged further away from the associated cutting edge with each subsequent finishing step.

In a sixth application, the workpiece is heat-treated, for example hardened or soft-annealed, in a region containing the workpiece part-side cutting edge of the cutting gap and/or in a region containing the residual grid-side cutting edge of the cutting gap. This can also be carried out in several steps, whereby according to one or more embodiments the finishing line is arranged further away from the associated cutting edge with each subsequent finishing step.

In a seventh application, the workpiece part-side cutting edge and/or an area of the partially cut out workpiece part containing the workpiece part-side cutting edge and/or the residual grid-side cutting edge of the cutting gap and/or an area of the residual grid containing the residual grid-side cutting edge are provided with a coating (e.g., zinc coating) during finishing. This can be done in a simple manner by adding a substance that produces the coating (e.g., zinc) to a second working gas beam. The second working gas beam is different from the (first) working gas beam, which is preferably guided coaxially to the processing beam. The area irradiated by the second working gas beam can be limited to the cutting edge(s), if necessary. The coating can also be carried out in several steps, whereby according to a preferred embodiment the finishing line is arranged further away from the associated cutting edge for each subsequent finishing step. By this measure, coated workpieces can also be thermally separated by a cutting beam in a particularly advantageous manner. A possible subsequent coating of the completely cut out workpiece part is not necessary.

The process according to the present disclosure for beam processing a workpiece is not limited to the applications described above or elsewhere herein. Rather, numerous other applications are conceivable in which the processes according to the present disclosure can be used advantageously.

During the finishing of the workpiece, the application cases described above as well as further application cases can be realized individually or in any combination.

In the processes for beam processing a workpiece according to the present disclosure, the processing beam is guided by the beam head and exits at a terminal beam nozzle, which is provided with a beam nozzle opening. In some embodiments, the beam nozzle tapers conically towards the workpiece or the workpiece support. The beam nozzle opening can be round. The processing beam can be in the form of a beam cone hitting the workpiece. The beam head can also serve to guide a (first) working gas beam, which can be emitted from the same beam nozzle as the processing beam and is preferably guided coaxially to the processing beam. The (first) working gas beam emerging from the beam nozzle of the beam head can be in the form of a gas cone hitting the workpiece. As mentioned above, the beam head can also be used to guide a second working gas beam, different from the first working gas beam, which serves to transport coating material and does not emerge from the same hole of the beam head as the processing beam.

The beam head can be moved relative to the workpiece. The workpiece, which can rest on a flat workpiece support, has a workpiece surface, for example a flat surface, opposite the beam head, onto which the processing and working gas beams can be directed for cutting processing and for finishing the workpiece.

The present disclosure further extends to beam processing devices with a processing beam guided by a beam head for beam processing of a plate-shaped or tubular workpiece, which has an electronic control device for controlling/regulating the beam processing of the workpiece, which is set up (programmatically) to carry out the process according to the present disclosure described herein. The electronic control device can include at least one processor and one or more memories coupled to the at least one processor and storing programming instructions for execution by the at least one processor to perform operations for the process of beam processing of plate-shaped or tubular workpiece as described in the present disclosure.

Furthermore, the present disclosure extends to program codes for an electronic control device suitable for data processing for such beam processing devices, which contain control instructions that cause the control device to carry out the process described above in accordance with the present disclosure.

Furthermore, the present disclosure extends to computer program products (storage medium) with a stored program code for electronic control devices suitable for data processing for such beam processing devices, which contain control commands that cause the control device to carry out the process described above in accordance with the present disclosure.

It is understood that the above embodiments of the present disclosure may be used alone or in any combination without departing from the scope of the present disclosure.

### DESCRIPTION OF DRAWINGS The present disclosure will now be explained in more detail with reference to exemplary embodiments with reference to the accompanying figures.

FIGS. 1-15 show an example of a process for beam processing a workpiece as described herein.

FIGS. 16-21 show various applications for finishing a workpiece as described herein.

FIG. 22-25 show an example of multiple finishings of a workpiece as described herein.

FIG. 26-28 show another example of multiple finishings of a workpiece as described herein.

FIG. 29 is a schematic representation of an example of a beam processing device for carrying out the processes according to the present disclosure for beam processing a workpiece.

FIG. 30 is a flow diagram of the processes according to the present disclosure.

### DETAILED DESCRIPTION

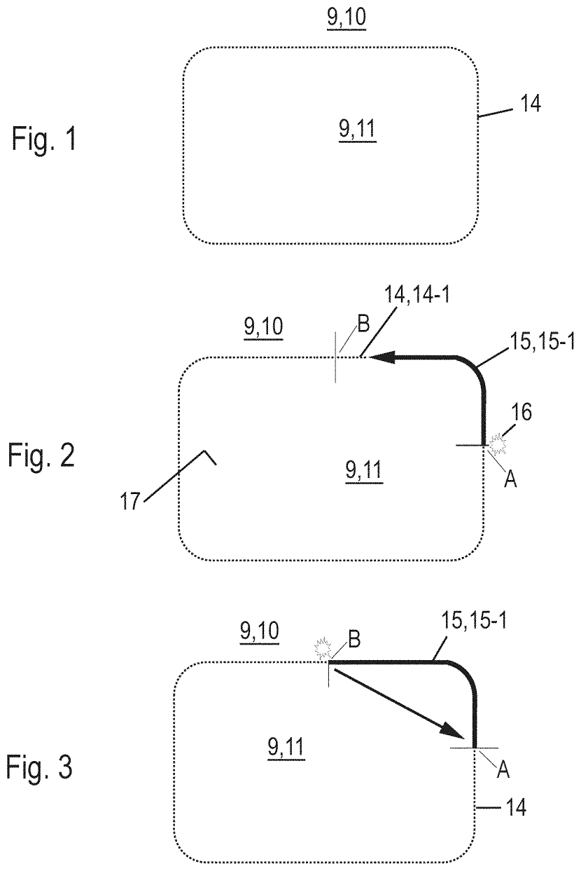

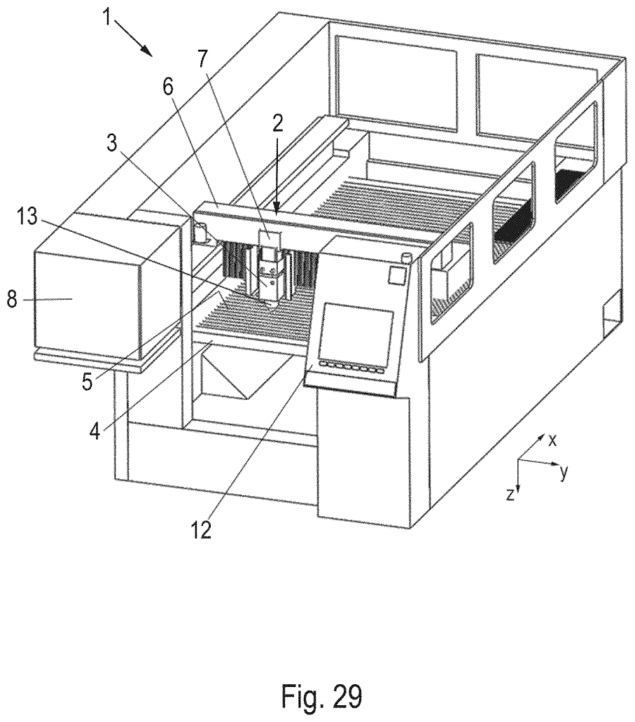

First of all, a beam processing device known per se for the beam cutting of plate-like workpieces is illustrated in FIG. 29. The beam processing device, altogether designated with the reference number 1, includes a beam cutting device 2 with a beam head 3, as well as a work table 4 with a workpiece support 5 for a workpiece 9 (not shown in FIG. 29, see FIGS. 1 to 15), for example a flat sheet metal plate. The workpiece support 5 is spanned by a cross member 6, which is guided so that it can be moved along a first axial direction (x-direction).

A guide carriage 7 for the beam head 3 is mounted on the cross member 6, which is guided on the cross member 6 so that it can move along a second axial direction (y-direction) perpendicular to the first axial direction. The beam head 3 can thus be moved in a plane spanned by the two axial directions (x-direction and y-direction) parallel and relative to, for example, the horizontal workpiece support 5. Furthermore, the beam head 3 is configured to be vertically movable in a third axial direction (z-direction) perpendicular to the first and second axial directions, whereby the distance perpendicular to the workpiece support 5 can be changed. In the case of a horizontal workpiece support 5, the z-direction corresponds to the direction of gravity. On its side facing the workpiece support 5, the beam head 3 has a conically tapering beam nozzle 13 towards the workpiece support 5. The beam head 3 serves to guide a processing beam, here for example a laser beam, as well as a working gas beam.

The processing beam is generated by a processing beam source 8 and guided to the beam head 3, for example, by a beam guiding tube and several deflecting mirrors or a light guiding cable. A focusing lens or adaptive optics can be used to direct the processing beam onto the workpiece in a bundled form. Because the beam head 3 can be moved along the first axis direction (x-direction) and the second axis direction (y-direction), the processing beam can approach any point on the workpiece. The working distance of the beam nozzle 13 to the workpiece can be adjusted by changing the distance (e.g., vertical distance) to the workpiece surface through the height adjustment of the beam head 3 in the z-direction. The distance of the beam head 3 from the workpiece surface, e.g., the cutting height, can be adjusted before, during, and after the cutting process. Cutting processing of the workpiece can be carried out, e.g., with a variable cutting height within a cutting height range. The focus position (or focal point) of the processing beam can be adjusted via optical elements in the beam head 3, for example adaptive optics.

A first working gas beam (not shown in more detail) is used to drive the melt out of the cutting gap. The working gas beam is generated by a gas beam generation device (not shown in more detail). The inert working gas used can be, for example, helium (He), argon (Ar) or nitrogen (N₂). Oxygen (O₂) can be used as the reactive working gas. The use of gas mixtures is also known. The working gas beam emerges from the same beam nozzle 13 as the processing beam 16 and is guided, e.g., coaxially to the processing beam 16, to the processing point and impinges there on the workpiece surface of the workpiece with an (initial) gas pressure predetermined by the gas beam generation device.

As shown in FIG. 29, the workpiece support 5 includes, for example, a number of support elements with, for example, triangular support point peaks, which together define a support plane for the workpiece 9 to be machined. The support elements are designed here, for example, as elongated support webs which each extend along the y-direction and are arranged next to one another in a parallel arrangement along the x-direction with, for example, a constant intermediate spacing. An extraction device is not shown in more detail, by means of which cutting smoke, slag particles and small waste parts produced during the beam cutting can be extracted.

A program-controlled control device 12 serves to control/regulate the process according to the present disclosure for beam processing the workpiece 9 in the beam device 1.

Reference is now made to FIGS. 1 to 15, in which an exemplary process for the beam processing of a workpiece by the beam processing device 1 of FIG. 29 is illustrated. FIGS. 1 to 15 correspond in this order to later situations of the process.

FIG. 1 shows a cutting line 14 (dashed line). The cutting line 14 is an imaginary line which corresponds to a complete contour (outline) of a workpiece part 11 to be cut out. The contour defines an outer shape of the workpiece part 11 to be cut out. The workpiece part 11 is to be cut out completely from a plate-shaped or tubular workpiece 9, which is not shown in greater detail, leaving the residual grid 10. The workpiece part 11 here has, for example, a rectangular shape with rounded corners, whereby it is understood that the workpiece part 11 can have any desired shape.

FIG. 2 schematically illustrates the processing beam 16, for example a laser beam, emerging from the beam head 3. The processing beam 16 is guided along the cutting line 14, whereby a cutting gap 15 is created in the workpiece 9 at a corresponding power density to cut the workpiece part 11 out of the workpiece 9. The beam head 3 can be moved to a position above the cutting line 14, in which the processing beam 16 meets a cutting position A of the cutting line 14 with its beam axis. As shown in FIG. 2, the beam head 3 is moved along the cutting line 14, whereby the processing beam 16 is moved from the cutting position A to a cutting position B. This creates the cutting gap 15 (solid line) between the first cutting position A and the second cutting position B, which breaks through the workpiece 9.

As can be seen from further explanations, the cutting gap 15 is created section by section, whereby a first section 15-1 of the cutting gap 15 is first created. The first section 15-1 of the cutting gap 15 is correspondingly generated in a first section 14-1 of the cutting line 14. It is understood that the processing beam 16 can also penetrate the workpiece 9 at a distance from the cutting line 14, whereby the cutting gap 15 in the sense of the present disclosure extends only along the contour (cutting line 14) of the workpiece part 11.

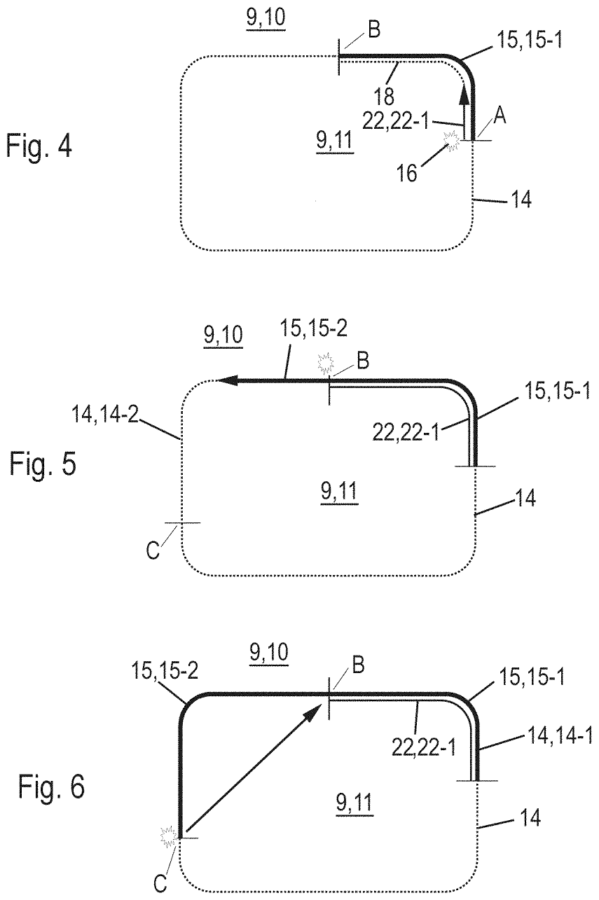

FIG. 3 illustrates a situation in which the first section 15-1 of the cutting gap 15 has been completely created between the cutting position A and the cutting position B. The cutting operation on the workpiece 9 is now interrupted. The processing beam 16 is switched off and the beam head 3 is moved to a position above the cutting position A of the cutting line 14. As illustrated by an arrow in FIG. 3, the traversing movement of the beam head 3 within the cutting line 14, e.g., above the workpiece part 11 to be cut out, can take place in a direct line between the cutting position B and the cutting position A of the cutting line 14. The cutting position A corresponds to a first finishing position of a finishing line 18 (see FIG. 4). It is equally possible that the workpiece part 11 to be cut is not passed over.

As illustrated in FIG. 4, the processing beam 16 is now switched on again and the beam head 3 is moved along the finishing line 18 (dashed line), whereby the processing beam 16 is moved from the first finishing position corresponding to the cutting position A to a second finishing position corresponding to the cutting position B. Here, the workpiece 9 is finished in a first section 22-1 of a finishing zone 22 (schematically illustrated by the solid line).

FIG. 5 shows a situation in which the workpiece 9 has been finished along the entire first section 15-1 of the cutting gap 15. The finished region or the first section 22-1 of the finishing zone 22 is schematically illustrated with a solid line. Analogous to the section-by-section creation of the cutting gap 15, the finishing zone 22 is created section-by-section. Specifically, the workpiece 9 is finished in the first section 22-1 of the finishing zone 22.

In FIG. 4 and further in FIGS. 5 to 15, the finishing line 18 and the finishing zone 22 respectively are shown offset parallel and equidistant to the cutting line 14 for display reasons. This also corresponds to positioning of the finishing line 18 for certain applications. For the finishing described here as an example, the finishing line 18 can be identical to the cutting line 14, which corresponds to equally positioning of the finishing line 18 for certain applications.

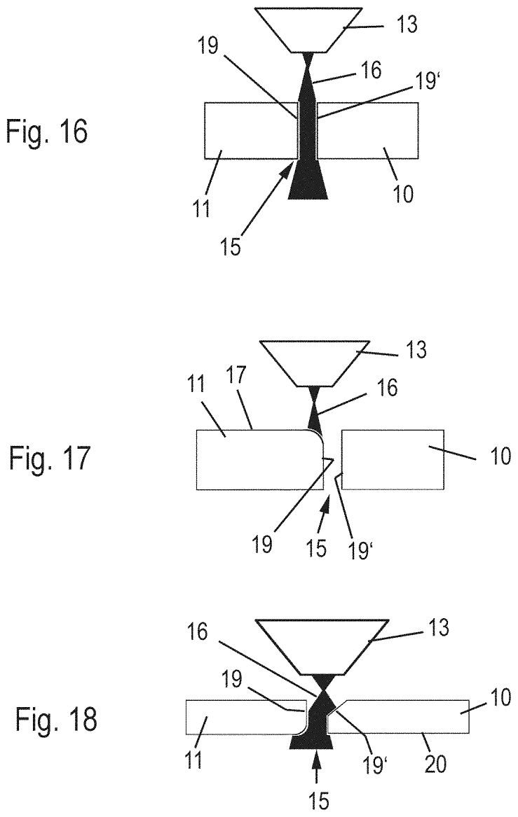

It is understood that the finishing zone 22 can have a wider dimension perpendicular to its extension than the finishing line 18, which is not shown graphically in the schematic representation. The finishing line 18 merely indicates the movement of the beam head 3. The finishing zone 22 is the area of the workpiece 9 that is finished by irradiation. The finishing line 18 extends along the cutting line 14. The finishing zone 22 can also extend along the cutting line 14. However, the finishing zone 22 does not have to contain the cutting line 14 and the cutting gap 15. In some embodiments, the finishing zone 22 may contain the cutting gap 15 or a portion of the cutting gap 15. The cutting gap 15 is delimited by two opposing cutting edges 19, 19′ (as illustrated with more details in FIGS. 16-28).

The finishing in a section of the finishing zone 22 is described by moving the beam head 3 from a respective first finishing position to a respective second finishing position. For each section of the finishing zone 22, the respective first and second finishing positions are indicated.

As illustrated in FIG. 5, starting from the cutting position B, which represents the first cutting position for the following second cutting procedure, the workpiece 9 is further cut, whereby the previously (or already) created first section 15-1 of the cutting gap 15 is extended to the cutting position C.

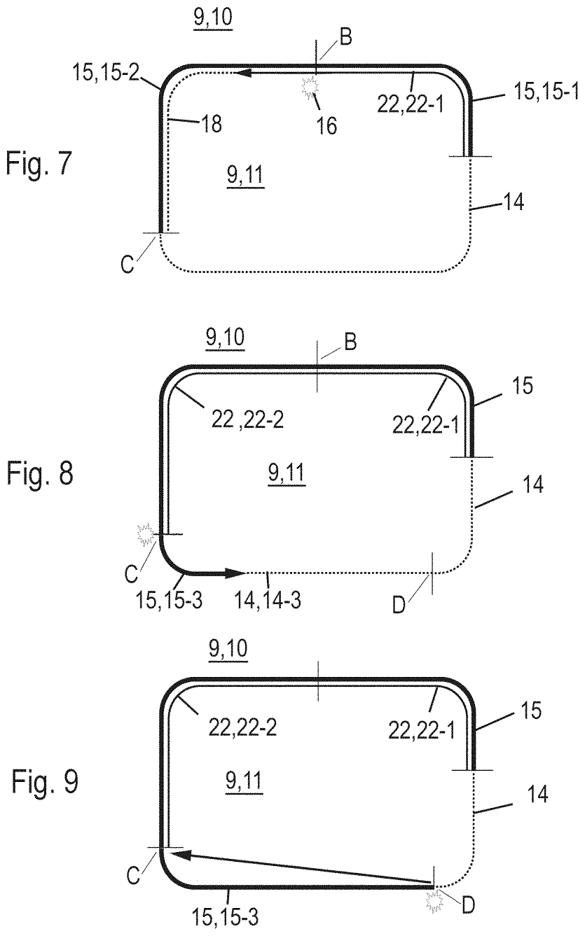

FIG. 6 illustrates a situation in which a further or second section 15-2 of the cutting gap 15 has been created between the cutting position B and the cutting position C along a second section 14-2 of the cutting line 14. The cutting operation on the workpiece 9 is now interrupted. The processing beam 16 is switched off and the beam head 3 is moved to a position above the first cutting position B of the cutting line 14, as illustrated by an arrow. The cutting position B corresponds to a first finishing position of the finishing line 18 for the following finishing (see FIG. 7).

As illustrated in FIG. 7, the processing beam 16 is switched on again and the beam head 3 is moved along the finishing line 18, whereby the processing beam 16 is moved from the first finishing position corresponding to the cutting position B to a second finishing position corresponding to the cutting position C.

FIG. 8 shows a situation in which the workpiece 9 has been finished along the entire second section 15-2 of the cutting gap 15 between the first finishing position corresponding to the cutting position B and the second finishing position corresponding to the cutting position C in a further or second section 22-2 of the finishing zone 22. The second section 22-2 of the finishing zone 22 extends the previously created first section 22-1 of the finishing zone 22.

As illustrated in FIG. 8, starting from the cutting position C, the workpiece 9 is then further cut, whereby the previously created part of the cutting gap 15 is extended to the cutting position D.

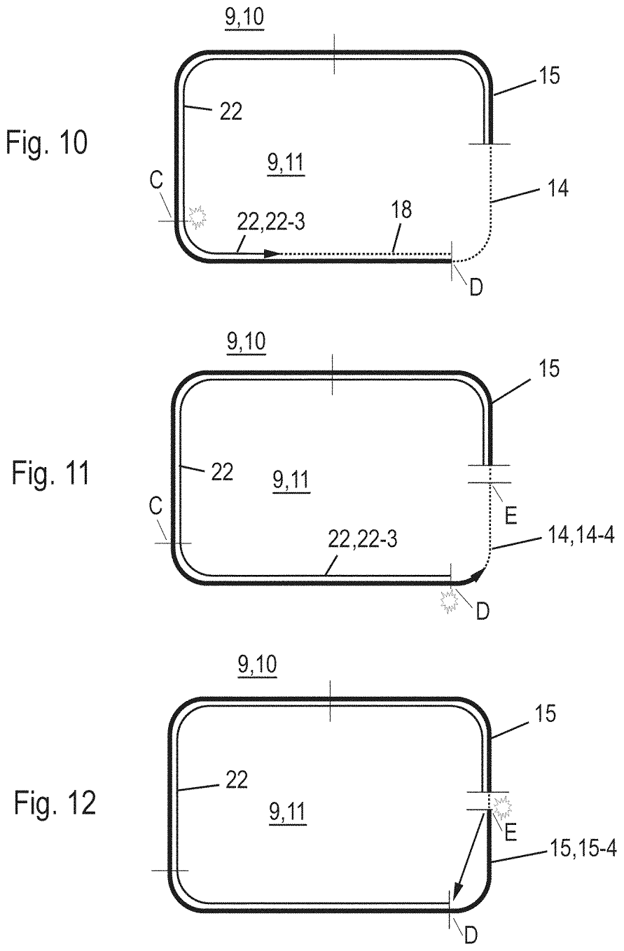

FIG. 9 illustrates a situation in which a third section 15-3 of the cutting gap 15 has been created between the cutting position C and the cutting position D along a third section 14-3 of the cutting line 14. The cutting operation on the workpiece 9 is now interrupted. The processing beam 16 is switched off and the beam head 3 is moved to a position above the cutting position C of the cutting line 14. The cutting position C corresponds to a first finishing position of the finishing line 18 for the now following finishing (see FIG. 10). The third section 15-3 of the cutting gap 15 extends the second section 15-2 of the cutting gap 15.

As illustrated in FIG. 10, the processing beam 16 is switched on again and the beam head 3 is moved along the finishing line 18, whereby the processing beam 16 is moved from the first finishing position corresponding to the cutting position C of the third cutting procedure to a second finishing position corresponding to the cutting position D.

FIG. 11 shows a situation in which the workpiece 9 has been finished along the entire third section 15-3 of the cutting gap 15 between the first finishing position and the second finishing position in a third section 22-3 of the finishing zone 22. The third section 22-3 of the finishing zone 22 extends the previously created second section 22-2 of the finishing zone 22.

As illustrated in FIG. 11, starting from the cutting position D, the workpiece 9 is further cut, whereby the previously created part of the cutting gap 15 is extended to the cutting position E.

FIG. 12 illustrates a situation in which a fourth section 15-4 of the cutting gap 15 has been created between the cutting position D and the cutting position E along a fourth section 14-4 of the cutting line 14. The cutting processing of the workpiece 9 is interrupted. The fourth section 15-4 of the cutting gap 15 extends the third section 15-3 of the cutting gap 15.

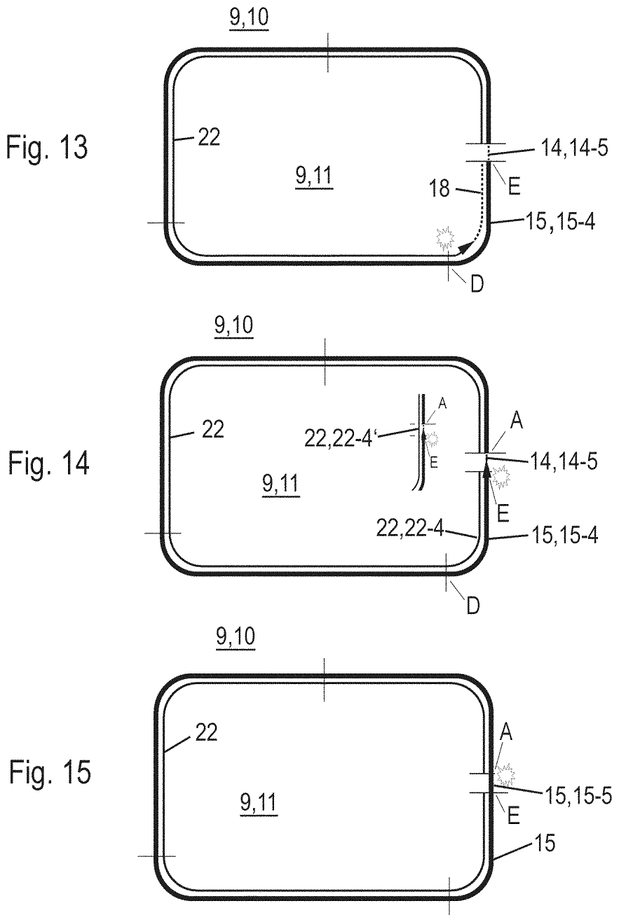

The processing beam 16 is switched off and the beam head 3 is moved to a position above the cutting position D. The cutting position D corresponds to a first finishing position of the finishing line 18 for the following finishing (see FIG. 13).

As illustrated in FIG. 13, the processing beam 16 is switched on again and the beam head 3 is moved along the finishing line 18, whereby the processing beam 16 is moved from the first finishing position corresponding to the cutting position D to a second finishing position corresponding to the cutting position E.

FIG. 14 shows a situation in which the workpiece 9 has been finished along the entire fourth section 15-4 of the cutting gap 15 between a first finishing position corresponding to the cutting position D and the second finishing position corresponding to the cutting position E in a fourth section 22-4 of the finishing zone 22. The fourth section 22-4 of the finishing zone 22 extends the previously created third section 22-3 of the finishing zone 22.

As illustrated in FIG. 14, starting from the cutting position E, the workpiece 9 is further cut, whereby the previously created part of the cutting gap 15 is extended to the cutting position A along a fifth section 14-5 of the cutting line 14. Hereby, the cutting gap 15 is closed and the workpiece part 11 is cut free from the remaining grid 10, so that it can be removed. There is no further finishing of the cut free workpiece part 11 since, according to the present disclosure, there is no finishing is performed on the cut free workpiece part 11. Here, a fifth section 15-5 of the cutting gap 15 is created which extends the fourth section 15-4 of the cutting gap 15.

In some embodiments, for the process exemplified by FIGS. 1 to 15, after finishing the workpiece 9 in the fourth section 22-4 of the finishing zone 22, but before the fifth section 15-5 of the cutting gap 15 is created, e.g., before the workpiece part 11 is cut free, further finishing of the workpiece 9 is carried out along a fifth section 14-5 of the cutting line 14 between the cutting positions E and A (see FIG. 14). This is schematically illustrated by an insert in FIG. 14. The extended fourth section 22-4′ of the finishing zone 22 extends here to the cutting position A (second finishing position), so that the finishing zone 22 extends as a closed, elongated area along the complete cutting line 14, e.g., fully over the complete contour of the workpiece part 11. In particular, during such a finishing operation, a chamfer can be created on one or both cutting edges of the cutting gap 15 to be created later in the area of the fifth section 14-5 of the cutting line 14. Subsequently, the workpiece part 11 is cut free by creating the fifth section 15-5 of the cutting gap 15.

In all cutting operations, the processing beam 16 has a first power density which is high enough such that the workpiece 9 is cut through. The first power density can assume (or have) different values, e.g., the first power density does not have to have a constant value. In all finishing operations, the processing beam 16 has a second power density which is controlled in such a way that the workpiece 9 is processed in neither a joining nor a cutting manner. In this way, the workpiece 9 is finished along the cutting line 14. The second power density can assume different values, e.g., the second power density does not have to have a constant value.

The beam axis of the processing beam 16 is, for example, axially parallel to the conical beam nozzle 13 and impinges perpendicularly on the workpiece 9. In all cutting operations and all finishing operations, the processing beam 16 is directed onto the workpiece surface 17 with an unchanged orientation of its beam axis relative to the workpiece surface 17 (e.g., 90°).

The finishing operations can be varied in many ways. For example, the finishing line 18 can be laterally offset (e.g., equidistant) from the cutting line 14. For example, the respective first finishing position and the respective second finishing position of a section 22-1 to 22-4 (22-4′) of the finishing zone 22 can also be positioned such that the workpiece 9 is only finished along a portion of the respective section 14-1 to 14-5 of the cutting line 14 or a portion of the respective section 15-1 to 15-5 of the cutting gap 15, e.g., the respective sections 22-1 to 22-4 (22-4′) of the finishing zone 22 do not extend over the complete length of the respective sections 14-1 to 14-5 of the cutting line 14 or do not extend over the complete length of the respective sections 15-1 to 15-5 of the cutting gap 15. For example, the direction of finishing can also be opposite to the direction of creation of the cutting gap 15.

In some embodiments, a respective section 14-1 to 14-5 of the cutting line 14 may be subjected to a single finishing operation. However, it is also possible that several finishing operations are carried out for the same part or section 14-1 to 14-5 of the cutting line 14. In some embodiments, during a first finishing operation of a same part or section 14-1 to 14-5 of the cutting line 14, the workpiece 9 is irradiated by the processing beam 16 in a region containing a workpiece part-side cutting edge 19 of the cutting gap 15 and/or in a region containing a residual grid-side cutting edge 19′ of the cutting gap 15. For example, when irradiating a cutting edge 19, 19′, the respective opposite cutting edge 19′, 19 is also irradiated.

In some embodiments, as shown in FIG. 15, the last (fifth) cutting procedure creates a part or section 15-5 of the cutting gap 15 whose length is smaller than the respective lengths of the parts of the cutting gap 15 created in all previous cutting operations. By this measure, it can be achieved that a possibly small part of the cutting gap 15 is not subjected to any finishing. It can also be possible for the lengths of the parts of the cutting gap 15 produced in the cutting procedures to increase continuously, for example, starting from the free-cutting point of the workpiece part 11. Alternatively, as described above in connection with FIG. 14, the workpiece 9 can still be subjected to a finishing operation before the workpiece part 11 is cut free in an area where the workpiece 9 still has connection to the residual grid 10. Thus, during the finishing of the last (fifth) section 14-5 of the cutting line 14, the workpiece 9 is first finished and then a (fifth) section of the cutting gap 15 is created for cutting free the workpiece part 11.

In some embodiments, the finishing line 18 has a meandering course along the cutting line 14. This allows the finishing zone 22 to be widened in a direction perpendicular to the cutting line 14.

Reference is now made to FIGS. 16 to 21, in which various applications for finishing the workpiece 9 in the process according to FIGS. 1 to 15 are illustrated.

In FIG. 16, oxide layers are removed from the workpiece part-side cutting edge 19 and the residual grid-side cutting edge 19′ of the cutting gap 15 during the finishing operation by the processing beam 16. The oxide layers can be easily removed by flaking. The processing beam 16 penetrates the cutting gap 15 and is focused so that both cutting gap edges 19, 19′ are irradiated. The finishing line 18 may be identical to or different from the cutting line 14.

Subsequent to the removal of the oxide layers or alternatively to the removal of the oxide layers, a coating (e.g., zinc coating) can be applied to the workpiece part-side cutting edge 19 and/or the residual grid-side cutting edge 19′ of the cutting gap 15. This is illustrated in FIG. 21, in which a second working gas beam 23, e.g., guided coaxially to the processing beam 16 is shown by a coating material 24 (e.g., zinc) transported therein. The coating material 24 is added to the second working gas beam 23, which, e.g., completely irradiates both cutting edges 19, 19′, with the result that the coating material 24 is deposited there and forms a coating (e.g., zinc coating).

In FIG. 17, during the finishing operation by the processing beam 16, the workpiece part-side cutting edge 19 of the workpiece part 11 adjacent to the workpiece surface 17 is rounded by re-melting. The finishing line 18 can be arranged laterally (e.g., equidistantly) offset relative to the cutting line 14, whereby, in some embodiments, a maximum distance between finishing line 18 and cutting line 14 is half of the cutting gap width of the cutting gap 15 plus the radius of the beam cone of the processing beam 16 at the workpiece surface 17.

In FIG. 18, during the finishing operation by the processing beam 16, the workpiece part-side cutting edge 19 adjacent to the workpiece underside 20 is simultaneously rounded and the residual grid-side cutting edge 19′ adjacent to the workpiece surface 17 is smoothed. The finishing line 18 can be the same as the cutting line or offset laterally (e.g., equidistantly) relative to the cutting line 14.

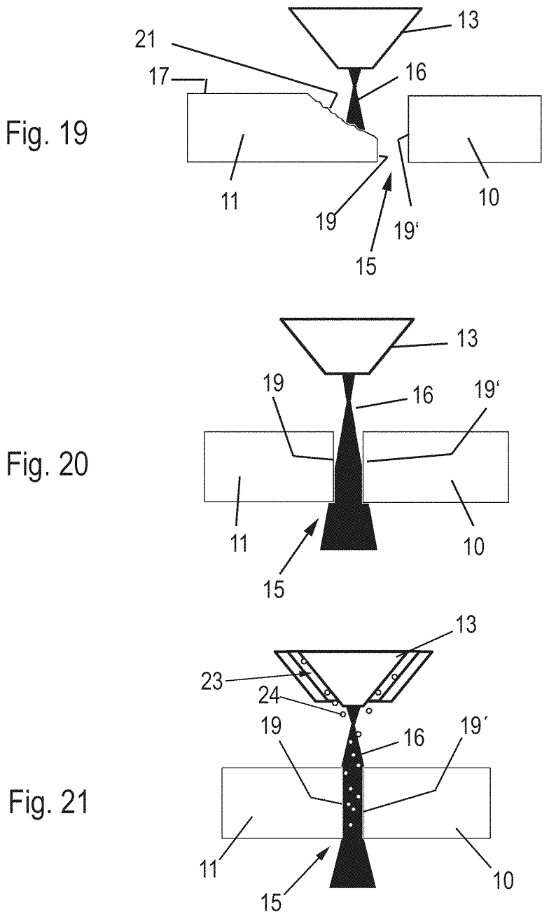

In FIG. 19, during finishing by the processing beam 16, the workpiece part-side cutting edge 19 adjacent to the workpiece surface 17 is provided with a chamfer 21. The finishing line 18 is laterally offset (e.g., equidistant) relative to the cutting line 14. Here, the chamfer 21 is created by, e.g., one or more steps or finishing procedures performed on the same section of the cutting gap 15. In a first finishing procedure, the workpiece part 11 is irradiated in an area containing the workpiece part-side cutting edge 19. The finishing line 18 may be the same as the cutting line or laterally offset (e.g., equidistant) relative to the cutting line 14 (in the direction of the workpiece part). This can be repeated one or more times if necessary. In one or more subsequent finishing operations, the finishing line 18 is offset even further towards or across the workpiece part 11 to form the chamfer 21 further away from the workpiece part-side cutting edge 19. In this case, the cutting edge 19 on the workpiece part side is no longer beam processed. It would also be conceivable to first irradiate the workpiece part 11 in such a way that an area not containing the cutting edge 19 on the workpiece part side is irradiated, followed by a continuous shifting of the finishing line 18 in the direction of the cutting gap 15, whereby finally the cutting edge 19 on the workpiece part side is also irradiated. In some embodiments, the processing beam 16 is moved in a meandering manner along the cutting line 14 when creating the chamfer 21, whereby the width of the chamfer 21 can be increased. In some embodiments, in addition to creating a chamfer 21, oxide is also removed from the workpiece 9 in the area of the cutting edge. It can also be possible to form a corresponding chamfer on the opposite side, e.g., the cutting edge 19′ on the residual grid side.

In FIG. 20, burr is simultaneously removed from the workpiece part-side cutting edge 19 adjacent to the workpiece underside 20 and from the residual grid-side cutting edge 19′ adjacent to the workpiece underside 20 during the finishing operation by the processing beam 16. The finishing line 18 can be identical to or different from the cutting line 14. The focus position of the processing beam 16 is adjusted so that the two cut edges 19, 19′ are irradiated accordingly.

The various applications can be provided individually or in any combination, in which case two or more finishing operations are carried out along at least one same part or section of the finishing zone 22 or along the complete finishing zone or along at least one same part or section of the cutting gap 15 or along the complete cutting gap 15 or along at least one same part or section of the cutting line 14.

The various applications can also be provided for in the variant described above, in which a finishing operation is carried out on the workpiece part 11 immediately before it is cut free in that area with which the workpiece part 11 is still connected to the residual grid 10 (fifth section 14-5 of cutting line 14). In some embodiments, a finishing operation can be, for example, the creation of a chamfer on the cutting edge 19′ on the side of the residual grid.

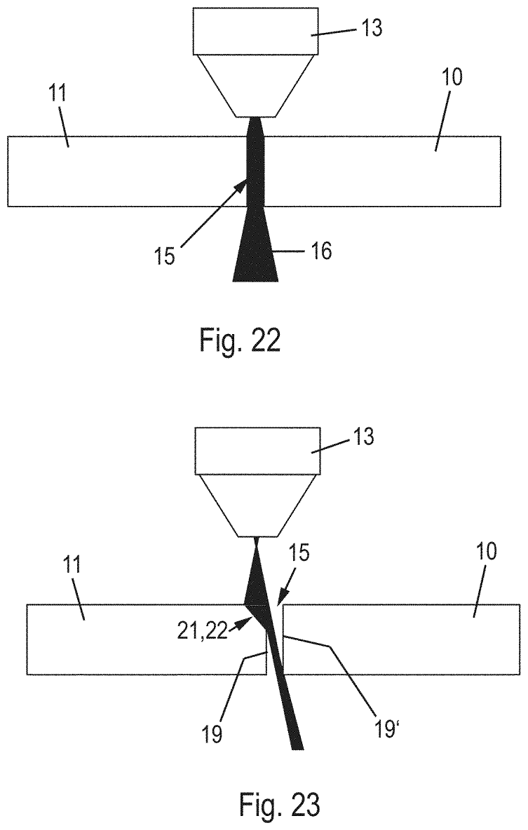

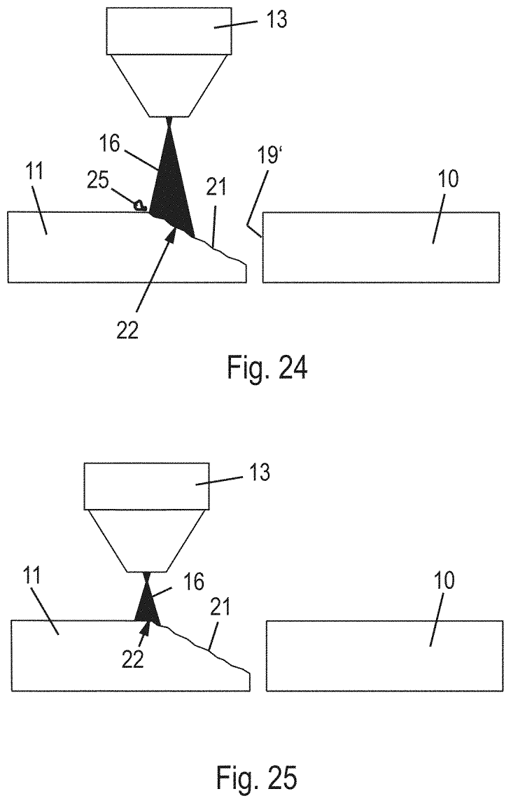

FIGS. 22 to 25 describe an example of multiple finishing of a workpiece 9. Accordingly, a cutting gap 15 is first created (FIG. 22). Then a chamfer 21 is created on the cutting edge 19 on the workpiece part side. In this case, the finishing zone 22 comprises the cutting edge 19 on the workpiece part side during the initial finishing (FIG. 23). Subsequently, the chamfer 21 is enlarged, whereby the finishing zone 22 no longer contains the cutting edge 19 on the workpiece part side (FIG. 24). In a further finishing operation, any adhesions 25, such as oxide, formed during the previous finishing operation are removed from the workpiece part 11 (FIG. 25).

It is clear from FIGS. 22 to 25 that, particularly in the case of a non-first-time finishing operation, the finishing zone 22 need not contain the cutting edges 19, 19′. As a rule, a finishing zone 22 at least partially contains a previous finishing zone 22.

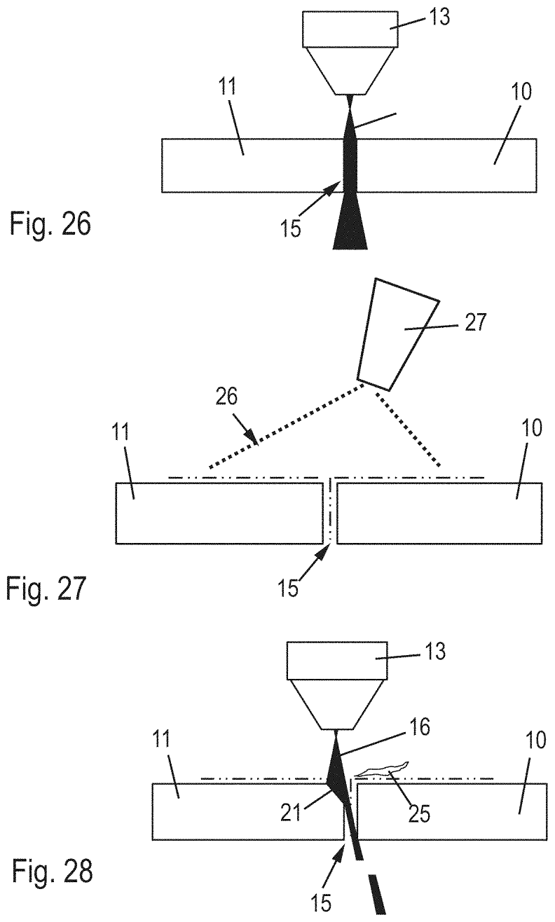

FIGS. 26 to 28 describe another example of multiple finishing of a workpiece 9. Accordingly, a cutting gap 15 is first created (FIG. 26). Then the workpiece 9 is coated with an anti-adhesive agent 26, for example an oil, in the area of the cutting gap 15. The coating is applied by an anti-adhesive agent nozzle 27, from which the anti-adhesive agent 26 emerges in the form of a jet cone in the direction of the workpiece 9 (FIG. 27). Furthermore, a chamfer 21 is created at the cutting edge 19 on the workpiece side (FIG. 28). The anti-adhesive agent 26 can be used to avoid adhesions 25 (e.g., slag or melt). This is shown schematically in FIG. 28.

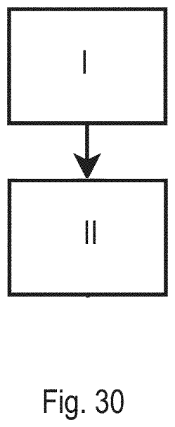

FIG. 30 shows a flow diagram of the process according to one or more embodiments of the present disclosure. The process includes creating at least a section of a cutting gap cutting through a workpiece along a cutting line corresponding to at least a part of a contour of a workpiece part to be produced from the workpiece with the processing beam (step I). It further includes finishing the workpiece with the workpiece part partially cut out one or more times in at least a portion of at least one finishing zone extending along the cutting line with the processing beam, where the workpiece is finished in the finishing zone in a non-joining and non-cutting manner (step II).

As can be seen from the above description, the present disclosure provides a novel process for beam processing of a plate-shaped or tubular workpiece, by which a workpiece part is partially or completely cut out and the workpiece part that has not yet been cut free (e.g., not completely cut out) and/or the residual grid along the cutting line, optionally along the cutting gap, is subjected to at least one finishing operation by the processing beam. This makes mechanical finishing of the cut-out workpiece part unnecessary, so that the production of workpiece parts can be carried out more simply, more quickly and more economically. In a particularly advantageous manner, due to the rigid, fixed position between the partially cut-out workpiece part and the remaining workpiece, a particularly precise finishing of the partially cut-out workpiece part can be carried out in a simple manner, so that high quality requirements can be met. An implementation of the process according to the present disclosure in previously existing beam processing devices is possible in a simple way without having to provide for complex technical measures. Rather, a desired finishing of a workpiece part still connected to the residual grid or of the residual grid itself can be realized by the process according to the present disclosure by merely intervening in the machine control.

### OTHER EMBODIMENTS

A number of embodiments of the present disclosure have been described. Nevertheless, it will be understood that various modifications may be made without departing from the spirit and scope of the present disclosure. Accordingly, other embodiments are within the scope of the following claims.

### LIST OF REFERENCE SIGNS

1 Beam processing device
2 Beam cutting device
3 Beam head
4 Work table
5 Workpiece support
6 Cross member
7 Guide carriage
8 Processing beam source
9 Workpiece
10 Residual grid
11 Workpiece part
12 Control device
13 Beam nozzle
14 Cutting line
14-1, 14-2, 14-3, 14-4, 14-5 Section of the cutting line
15 Cutting gap
15-1, 15-2, 15-3, 15-4, 15-5 Section of the cutting gap
16 Processing beam
17 Workpiece surface
18 Finishing line
19, 19′ Cutting edge
20 Workpiece underside
21 Chamfer
22 Finishing zone
22-1, 22-2, 22-3, 22-4, 22-4′ Section of the finishing zone
23 Second working gas beam
24 Coating material
25 Adhesion
26 Anti-adhesive agent
27 Anti-adhesive agent nozzle

What is claimed is:

1. A method for beam processing of a plate-shaped or tubular workpiece, comprising:
generating at least one section of a cutting gap cutting through the workpiece along a cutting line by a processing beam, the cutting line corresponding to at least part of a contour of a workpiece part to be produced from the workpiece; and
performing at least one non-joining and non-cutting finishing treatment of the workpiece with a partially cut-out workpiece part in at least one section of at least one finishing zone by the processing beam, wherein the at least one finishing zone extends along the cutting line.

2. The method of claim 1, wherein the finishing treatment of the workpiece is performed between generation of two sections of the cutting gap.

3. The method of claim 1, wherein the finishing treatment of the workpiece is performed in a section of the at least one finishing zone extending at least partly along a section of the cutting gap.

4. The method of claim 1, wherein the finishing treatment of the workpiece is performed in a section of the at least one finishing zone that at least partially does not include a section of the cutting gap.

5. The method of claim 4, wherein the finishing treatment of the workpiece is performed continuously in the section of the at least one finishing zone that extends along the section of the cutting gap.

6. The method of claim 1, wherein sections of the cutting gap successively extend the cutting gap.

7. The method of claim 1, wherein a last-generated section of the cutting gap has a length that is shorter than respective lengths of previously generated sections of the cutting gap.

8. The method of claim 7, wherein the lengths of the sections of the cutting gap, starting from a free-cutting point of the workpiece part, are kept constant or increase counter to a direction for generating the cutting gap.

9. The method of claim 1, wherein, during a finishing treatment of the workpiece, at least one of a workpiece part-side cutting edge of the cutting gap or a residual grid-side cutting edge of the cutting gap is included in the at least one section of the at least one finishing zone.

10. The method of claim 1, comprising:
prior to a finishing treatment of the workpiece in a section of the at least one finishing zone, applying a layer of an anti-adhesive agent to the workpiece at least in the finishing zone, the anti-adhesive agent being configured to inhibit adhesion of substances produced during the finishing treatment.

11. The method of claim 1, wherein the processing beam is guided with a meandering movement along at least one section of the cutting line during performing the at least one non-joining and non-cutting finishing treatment of the workpiece.

12. The method of claim 1, comprising:
cutting free the workpiece by the processing beam after performing one or more finishing treatments of the workpiece.

13. The method of claim 1, wherein performing the at least one non-joining and non-cutting finishing treatment of the workpiece comprises at least one of:
i) removing an oxide layer formed when generating the cutting gap,
ii) removing a burr in the region of the cutting gap,
iii) rounding one or more cutting edges delimiting the cutting gap,
iv) changing a shape of at least one cutting edge delimiting the cutting gap,
v) generating a chamfer along the cutting gap,
vi) heat-treating the workpiece along the cutting gap, or
vii) coating the workpiece along the cutting gap.

14. The method of claim 1, wherein, during performing the at least one non-joining and non-cutting finishing treatment of the workpiece, the partially cut-out workpiece part is not completely cut out of the workpiece and remains firmly connected to the workpiece.

15. The method of claim 1, wherein the processing beam has a first power density for generating the at least one section of the cutting gap and a second power density for performing the at least one non-joining and non-cutting finishing treatment of the workpiece, and wherein the second power density is smaller than the first power density.

16. The method of claim 1, wherein the finishing treatment of the workpiece is performed along one of:
a finishing line identical to the cutting line, or
a finishing line laterally offset from the cutting line.

17. A beam processing device comprising:
a beam head configured to guide a processing beam; and
an electronic control device configured to control beam processing of plate-shaped or tubular workpieces, wherein the electronic control device comprises:
at least one processor; and
one or more memories coupled to the at least one processor and storing programming instructions for execution by the at least one processor to perform operations comprising:
generating at least one section of a cutting gap cutting through a workpiece along a cutting line by a processing beam, wherein the cutting line corresponds to at least part of a contour of a workpiece part to be produced from the workpiece; and
performing at least one non-joining and non-cutting finishing treatment of the workpiece with a partially cut-out workpiece part in at least in one section of at least one finishing zone by the processing beam, wherein the finishing zone extends along the cutting line.

18. A non-transitory computer readable storage medium having machine-executable instructions stored thereon that, when executed by at least one processor, cause the at least one processor to perform operations for beam processing of a plate-shaped or tubular workpiece, the operations comprising:
generating at least one section of a cutting gap cutting through the workpiece along a cutting line by a processing beam, wherein the cutting line corresponds to at least part of a contour of a workpiece part to be produced from the workpiece; and
performing at least one non-joining and non-cutting finishing treatment of the workpiece with a partially cut-out workpiece part in at least in one section of at least one finishing zone by the processing beam, wherein the finishing zone extends along the cutting line.
